(19) United States
(12) Patent Application Publication
(10) Pub. No.: US 2007/0162306 A1
(43) Pub. Date: Jul. 12, 2007

(54) SYSTEM AND METHODS FOR PERFORMING DISTRIBUTED PAYMENT TRANSACTIONS

(76) Inventors: James D. Peters, Alpharetta, GA (US); Gary M. Austin, Marietta, GA (US)

Correspondence Address: MCGUIREWOODS, LLP, 1750 TYSONS BLVD, SUITE 1800, MCLEAN, VA, 22102, US

(21) Appl. No.: 11/622,388

(22) Filed: Jan. 11, 2007

Related U.S. Application Data
(63) Continuation of application No. 60/758,433, filed on Jan. 11, 2006.
(60) Provisional application No. 60/758,283, filed on Jan. 11, 2006.
(60) Provisional application No. 60/758,325, filed on Jan. 11, 2006.
(60) Provisional application No. 60/758,395, filed on Jan. 11, 2006.

(51) Int. Cl. G06Q 10/00; G06Q 40/00

(52) U.S. Cl. 705/2; 705/4; 705/39

(57) ABSTRACT

An interoperable process and device for its practice for ensuring that a payment is made by a payor for services rendered. The process includes receiving information from at least one stakeholder indicating that a payment process should be completed. The process further includes funding a service provided by a service provider that has been provided.

### CROSS-REFERENCE TO RELATED APPLICATIONS

This application claims the benefit of U.S. Provisional Patent Application No. 60/758,325, U.S. Provisional Patent Application No. 60/758,395, U.S. Provisional Patent Application No. 60/758,433 and U.S. Provisional Patent Application No. 60/758,283, each of which were filed on Jan. 11, 2006, and are incorporated by reference herein, in their entirety. Further, this application is related to U.S. patent application Ser. No. ______, entitled “TOOLBAR USER INTERFACE FOR INFORMATION SYSTEM,” U.S. patent application Ser. No. ______, entitled “SYSTEM AND METHOD FOR A SECURE PROCESS TO PERFORM DISTRIBUTED TRANSACTIONS,” and U.S. patent application Ser. No. ______, entitled “SYSTEM AND METHODS FOR PERFORMING DISTRIBUTED TRANSACTIONS,” each of which are being filed simultaneously herewith, having at least one common inventor, and are incorporated by reference herein, in their entirety.

### BACKGROUND OF THE INVENTION

1. Field of Invention

This invention relates generally to extending business interoperability to business entities, and, more particularly, to a system and process for efficiently extending interoperability for communications and data related to payment transactions to business entities in an overall business sector, such as the healthcare sector.

2. Related Art

Generally, the issues facing certain businesses, such as the healthcare industry, include the continuing need for efficiency in each of the industry market verticals (“Vertical(s)”) such as clinics, hospitals, insurance payers, etc. and (b) the lack of effectiveness for transactions, such as payment transactions, that occur across these vertical segments, affecting the entire healthcare market sector (“Sector” or “Horizontal”). The ability to effectively conduct business electronically, across and between these Verticals in the entire healthcare Sector is referred to as interoperability. Whereas solutions from various companies exist that attempt to make the Verticals more efficient, there is no solution in the marketplace that makes the overall market sector effective. Generally, efficiently means to do things right with less time and/or energy; effectively means to do the right things.

Looking into each of the two issues identified above we note: Regarding the Vertical market segments, many companies have and continue to invest their resources and energies in making the Verticals more efficient through automation. This process is by no means complete, but the various market competitors continue to improve their products to deliver higher process efficiencies in each of these market segments. Examples of such companies are NextGen, GE Healthcare, Greenway Technologies, eClinicalWorks, Allscripts and others who have developed and market software solutions that increase the efficiency of clinics and medical offices. Similarly, corporations such as CERNER, SMS, McKesson and others have developed and market solutions that make hospitals more efficient. Others have done the same for other industry Verticals that contribute to the healthcare process, such as the insurance segment, the banking segment, the pharmacy segment, etc.

The lack of efficiency in the Vertical segments has been reviewed by the Institute of Medicine in the Untied States. On Mar. 1, 2001, the Institute of Medicine issued a report entitled Crossing the Chasm: A New Health System for the 21st Century that clearly describes the state of the healthcare industry in the United States. Specifically, this report states that the healthcare industry is in dire need of automation in all its operations, including hospitals, clinics and doctors in their practices (“Healthcare Providers”). This lack of automation causes healthcare to be expensive and inefficient, and it impedes the ability of healthcare providers to electronically share patient data, clinical and payment information. Such inefficiencies result not only in lost earnings (for example, it is estimated that in many cases as much as thirty percent (30%) of insurance claims are not paid because they cannot be processed due to improper coding), but also in exposure to potential legal liability that causes related insurance premiums to remain very high.

The present lack of Interoperability can be illustrated by the following quote from an independent and credible third-party. The Health and Human Services (HHS) Secretary in 2006 said: “The U.S. health care system needs an interoperable electronic health records and billing system. . . . I've come to conclude there really isn't a health care system. There's a health care sector. . . . There's really nothing that connects it together into an economic system.”

Furthermore, a federal statute governing the use of healthcare information, the Health Insurance Portability and Accountability Act of 1996, known as HIPAA, imposes federal requirements that affect healthcare providers and other covered entities. The regulations implementing HIPAA mandate certain changes that all healthcare providers must effect in their operations.

Regarding the effectiveness of conducting business across the overall Sector, we note that there are numerous “Stakeholders” in the Healthcare Sector, including: Patients; Hospitals (including Urgent Care); Primary Physicians; Specialist Physicians; Pharmacies; Insurance Payers; Laboratories (for various tests, imaging, pulmonary, cardio, etc.); Pharmaceutical Companies; Banks that handle transaction payments including HAS/FSA accounts; Clearing Houses that negotiate a discounted network of services; Employers who participate in the payment of insurance premiums; Government that regulates and insures; and Associations that act as volume purchasing groups, such as Independent Physician Associations and Unions. Generally, a “Stakeholder” may be an individual, or corporation or other type of business who derives a business or personal benefit of any kind, and/or who contributes or participates in the delivery of healthcare services.

Whereas many companies are working hard to make each of these Stakeholders efficient (Verticals), there is no other solution in the marketplace that make the Horizontal processes effective (that is to say across the entire Healthcare Sector), at this time, nor is there a common infrastructure over which these stakeholders can conduct business effectively, in an automated way. In fact, it has been estimated that over 90% of some 30 billion healthcare transactions per year in the U.S. are paper based.

Moreover, there is a general mistrust among the key stakeholders, which is more or less natural in a market that is fraught with errors, fraud, inefficiency and shrinking margins. For example, in 2006, the head of the U.S. Department of Health and Human Services (HHS) has stated that in his estimate, that up to 25% of all Medicare transactions may be fraudulent.

This conflict is one of the main reasons why the various Stakeholders in healthcare do not collaborate, and hence the result is a disjointed, semi-automated and expensive healthcare delivery system, as illustrated in FIG. 1, where some of the Stakeholders are shown as pieces of a disjointed puzzle. i.e., there is no common infrastructure among Stakeholders. Furthermore, because collaboration is important but not mandatory for effectiveness, it is difficult for any one of the major players to play a leading role, due to objections by their competitors. For example, if a first large insurance company would take an initiative to resolve some of the key industry problems, why would a second insurance company collaborate and risk losing market share? The answer is likely they would not. It becomes obvious that the marketplace would favor an independent party, especially one that offers advantages to each of the healthcare stakeholders.

It should be noted that parts of the effectiveness solution are addressed by initiatives that are typically sponsored by various States of the Union and referred to as Regional Health Information Organizations (“RHIO”), such RHIOs are generally concerned with and attempt to provide a standard with which to electronically share medical records with care providers, such as hospitals, clinics and physicians. In this RHIO environment, the participating Stakeholders are limited to healthcare providing entities, and the type of information they share is limited to medical records. But, this fails to address the needs of all types of Stakeholders, in all of the various products and services they require, including medical records. Examples of the additional products and services addressed by this invention include but are not limited to: Records and benefits that individuals (and their families) derive from their membership in Associations; employment data, including detailed healthcare benefits; records and access to banking products of the individuals for healthcare related accounts, such as Health Savings Accounts and other financial matters, such as records for healthcare tax exemptions; records of medications individuals have been prescribed and other related issues, such as whether they have purchased their medication, etc.

In particular, many payment systems exist for other industries, however no such efficient and interoperable payment system has been introduced for the healthcare sector. The present payment system takes weeks or months to complete payment transactions. Thus, there is a need for a system and/or process to reduce the time from payment request to actual payment to days or minutes. In other words, there is a need for an effective solution to the flow of payment from, for example, payor to the provider.

### SUMMARY OF THE INVENTION

The invention meets the foregoing need and allows a provider to be quickly and efficiently paid and the payor too quickly and efficiently documentation and the like, which results in a significant cost savings and other advantages apparent from the discussion herein.

More specifically, the invention improves the execution and management of the Payment process to Providers of healthcare services, because existing processes outside of this invention may and often do (a) impede and often cause an unreasonably long period of time for the reimbursement and collection of payment to Providers (b) cause claims to be resubmitted as the existing semi-automated systems in place at most Provider businesses do not accommodate effective handling of disputes over payment, thereby increasing costs and (c) payers may (at times intentionally) delay payment or require justification evidence that an electronic payment switch can readily produce but existing manual processes either cannot or require extensive effort to produce and attach to the same payment claim, as they follow different submission paths.

Accordingly, in one aspect of the invention a process of ensuring that a payment is made by a payor for services rendered includes the steps of receiving information indicating that a service has been rendered by a service provider and a payment process should be completed, exchanging information with at least one entity regarding the service rendered by the service provider and the payment process, and directing funding of the service provided by a service provider that has been provided after determining that payment is appropriate based on the information.

The at least one entity may include one of an IHR patient database, a merchant processor, e-prescriber, a collections entity, trust administrator, claims administrator, a financial institution, and a PPO re-pricer. Exchanging information may include receiving at least one of claims administration data from an insurance entity, payment information from a merchant processor, patient data, collections information, and medical data. The entity may include various individuals of the medical industry. The service may include a healthcare medical visit and payment process is the payment for the service. The process further may include patient fee collection. The payment process further may include merchant payment processing. The process may include an electronic prescription processing. The process may include receiving information from an electronic check-in. The step of administering claims through at least one of a PPO or a re-pricer. The step of funding the service provider with a first advance amount. The step of funding the service provider with a remaining advance amount. The step of recording data for the RHIO or for mining various outcomes based on received data.

According to another aspect of the invention a payment processing transaction system includes a platform configured to receive information indicating that a service has been rendered by a service provider and a payment process should be completed, said platform further configured to exchange information with at least one entity regarding the service rendered by the service provider and the payment process, and said platform further configured to direct funding of the service provided by a service provider that has been provided after determining that payment is appropriate based on the information.

The at least one entity may include one of an IHR patient database, a merchant processor, e-prescriber, a collections entity, trust administrator, claims administrator, a financial institution, and a PPO re-pricer. The exchanging information may include receiving at least one of claims administration data from an insurance entity, payment information from a merchant processor, patient data, collections information, and medical data.

In yet another aspect of the invention a system of ensuring that a payment is made by a payor for services rendered includes means for receiving information indicating that a service has been rendered by a service provider and a payment process should be completed, means for exchanging information with at least one entity regarding the service rendered by the service provider and the payment process, and means for directing funding of the service provided by a service provider that has been provided after determining that payment is appropriate based on the information.

The at least one entity may include one of an IHR patient database, a merchant processor, e-prescriber, a collections entity, trust administrator, claims administrator, a financial institution, and a PPO re-pricer. The exchanging information may include receiving at least one of claims administration data from an insurance entity, payment information from a merchant processor, patient data, collections information, and medical data.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows the conceptual lack of infrastructure among various stakeholders without the invention;

FIG. 2 shows the interaction of the various stakeholders interoperating with a platform according to the principles of the invention; and

FIGS. 3 and 4 show a provider payment flow process according to the principles of the invention.

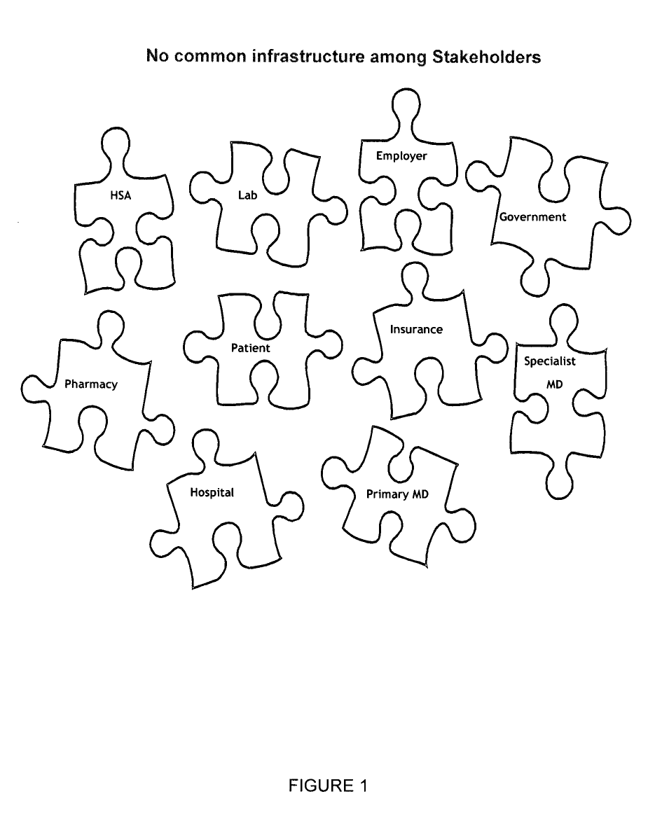

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The payment system of the invention includes near real time:
Pre-authorization;
Auto-eligibility;
Verified Patient ID through biometric identification;
Access to other Interoperability functions;
Plan Benefits Pre-determination, based on “Clean Claims”;
Recognizing “Clean Claims” i.e. claims that have all the required elements and justifications, including but not limited to coding, so the insurance company will pay the claim) etc.;
Holding payment processes in “suspense” until healthcare transactions complete (for example waiting for Lab test results, to establish whether the insurance or the patient are responsible for payment);
Real time link to Automatic Check Clearing and Credit Card Processing;
Prompt Payment of Claims based on being “Clean” or not;
Providing appropriate financial cards (credit or debit) with which Participants may conduct their transactions, periodically; and
Managing the payments and collections process in an automated fashion, but also with a telephone accessed Help Desk service, including the keeping of records for all related transactions with reports and performance statistics.
   This is achieved through a payment transaction platform or other similar system implementing an interoperability process as described below in a particular example of the healthcare field.

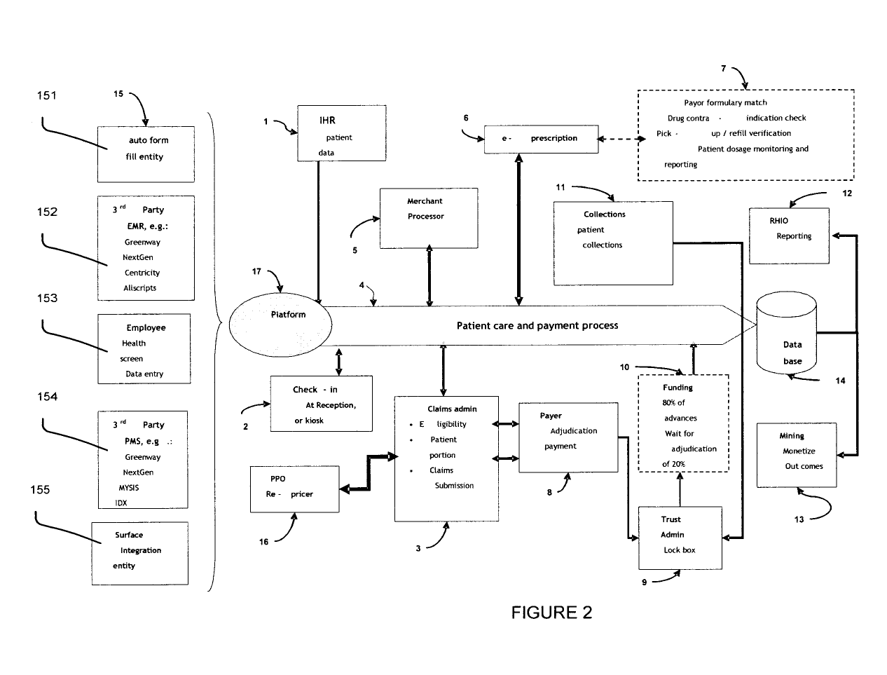

FIG. 2 shows the interaction of the various stakeholders interoperating with a platform according to the principles of the invention. In particular, FIG. 2 initially shows, as indicated by arrow 15, a series of exemplary specific tasks that may qualify for transaction payment when the invention is implemented in the healthcare field. More specifically an automatic form field entity 151 is a computer based entity that allows for various common forms to be completed and submitted into the payment system of the invention to receive payment therefrom. Although the below described example is with respect to the healthcare field, other implementations and other fields or technology sectors is contemplated in the invention and is within the spirit and scope thereof.

Another type of task that would qualify for the transaction of payments may be an operation in a third-party electronic medical record (EMR) 152 platform such as a software product used in a physicians office. Examples of such EMR platforms 152 include Greenway, NextGen, Centricity, Allscripts, and the like. Such EMR platforms 152 provide interaction between the employees or operators in a physician's office and the patients receiving medical care.

Another example of a transaction that would provide payment to a provider from a payor is the employee entering data in a health screen data entry operation as shown by box 153. In particular, an employee can submit various information during a health screen data entry operation. Such information may then be input to the system of the invention to cause a payment transaction to be initiated such as HSA accounts, FSA accounts, and the like

Yet another example of a task that may generate payment would be a third-party physician's management system (PMS) 154 such as Greenway, NextGen, MYSIS, IDX, and the like. Such third-party PMS systems 154 providing similar functionality as that with the EMR platforms noted above together with other known functions and also initiating payment transactions.

Yet another task that may initiate a payment transaction is a surface integration entity 155. Surface integration entities include physical or electronic forms that may be required by third parties (such as checks, credit card vouchers, electronic funds transfer, etc.) for which items the extent of which includes generating stakeholder address IDs, financial institution IDs, amount of transaction, party for payment etc., but not specific application integration with respect to a program environment.

Accordingly, these various tasks and others may initiate the payment transaction process. The initiation of the payment transaction process takes place through software/platform disclosed herein and also in the cross-reference related applications noted above. This platform receives the pertinent data from the various tasks 15 and initiates and completes the payment transaction. The platform is noted in FIG. 2 as payment transaction platform 17 that may interact with the various tasks 15 for receiving data, information and the like.

Once the payment transaction platform 17 receives information that may qualify for a transaction payment, the payment transaction platform 17 may then collect and verify individual health record data such as through the IHR patient data portion 1. Thereafter, the payment transaction platform 17 may continue the patient care and payment process as indicated by the arrow 4. The financial transaction for the patient encounter may process through a number of steps as shown in FIG. 2-4 that may be required for transaction payment.

For example, a patient can check-in at a reception in a physician's office or at a kiosk, if one is used, at the beginning of a medical visit. This check-in process interacts and exchanges data with the patient care and payment process portion 4 to ensure transaction payment.

In order to pay their portion of the medical visit, the patient may then interact through the payment process 4 with a merchant processor 5. The merchant processor 5 includes any form of credit card, debit card or automatic check clearing process as is known in the art. Of course other types of electronic payments are contemplated by the invention.

If during the medical visit the physician provides the patient with a prescription, the prescription may be electronically filled. An e-prescription 6 may be transmitted to a pharmacy as noted in FIG. 2. The e-prescription 6 process may include a payor formulary match, drug contra-indication check, pick-up/refill verification, patient dosage monitoring and recording as indicated in the dashed box 7. With the e-prescription 6, the patient then can move forward to the pharmacy of their choice including mail pharmacy in order to receive their prescribed medication.

A claims administration process portion 3 may determine eligibility of the patient, the patient portion of the medical visit, and claims submission of the medical visit. Additionally the claims administration portion 3 may interact with a PPO re-pricer 16. The PPO re-pricier may be part of the PPO network and it provides various data to or from the claims of administration 3. Whereby a claim that is presented by a provider for rendered health care services is re-priced by the PPO to reflect contractual agreements the PPO may have with the insurance carrier. The details of which are not necessary for review by the provider. The claims administrator 3 also interacts with the payor 8. The payor 8 is able to provide a co-pay and/or cost amount to the claims administrator 3. The payor may be, in particular, an insurance company.

Once the initial visit is completed, then the payor 8 may allow for the initial funding of the patient visit. In particular, the payor 8 may notify the trust administration lock box 9 which may typically be implemented as a bank to move forward with funding. The funding 10, as shown in FIG. 2, may provide a partial (80% for example) advance of the cost of the patient visit. The remaining (20%) may wait until an adjudication process is complete. Accordingly the funding 10 provides for quick efficient and automated payment to the physician.

Additionally the payment transaction platform 17 and the system overall may include a collections unit 11. Accordingly, the collections 11 may allow for various patient collection processes resulting from, for example, bad checks and the like.

Accordingly, all the information that is received or sent from payment transaction platform 17 may be saved in a data base 14. The information in the data base 14 has a monetary value and may be used in various reports and the generation of outcome based information. In particular regional health information organizations may use the information for reporting as indicated by box 12. Similarly the data health and data base 14 may be mined in order to monetize it to determine various outcomes based on the criteria listed in the information.

It should be noted the payment transaction platform 17 in the interactions with the various stakeholders may require payment of a fee or may include receipt of a payment. Accordingly the payment transaction platform 17 is able to interact with each of these stakeholders in order to pay those fees and/or receive those payments of fees and complete the patient care and payment process 4 as noted in FIG. 2.

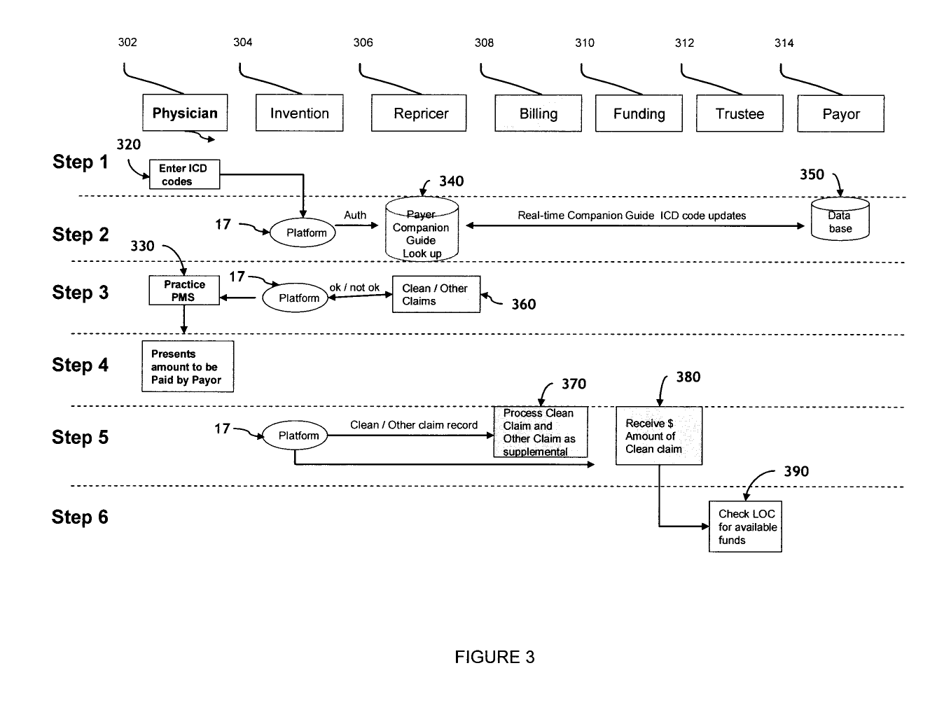

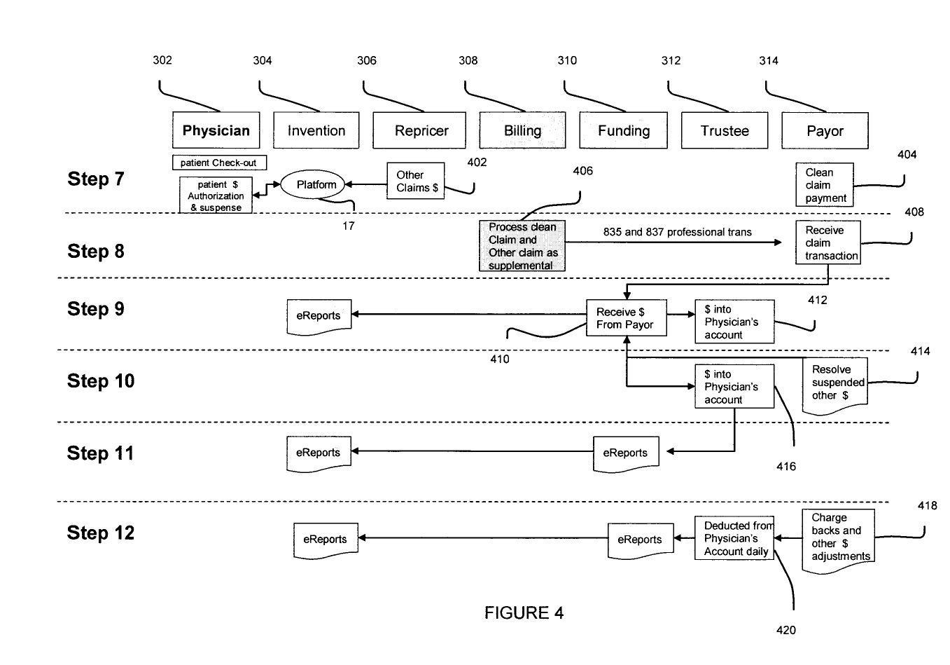

FIGS. 3 and 4 show a provider payment flow process according to the principles of the invention. In particular, FIGS. 3 and 4 show the various stakeholders involved in the invention including a physician 302, platform of the invention 304, re-pricer 306, billing 308, funding 310, trustee 312, and payor 314 just to name a few. Accordingly the flowchart of FIGS. 3 and 4 show the interaction with the various stakeholders 302-314 with each other and the invention along various steps.

As noted in step 1, a physician may provide various services to patients during their visit. At some point and time during their visit the physician may enter the international classification of disease (ICD) information into a tablet PC for other clinic application. This data may then be forwarded to the payment transaction platform 17 as noted in step 2 as part of the invention 304. The payment transaction platform 17 may route the information to the payor companion guide look up 340 seeking authorization prior to check out from the physician's office of the patient in real time or near real time. The companion guide look up table may forward the ICD codes to a data base 350 and receive the updates therefrom.

In step 3 the pre-pricer 306 may determine whether a claim is clean or otherwise by searching the payor data base for the companion guide ICD codes. This information is forwarded to the payment transaction platform 17 and also to the practice management system 330 as shown in step 3. At step 4 the information from the PPO pre-pricier 306 computes the physician discount and the information is presented to be paid by the payor in step 4.

In step 5 the payment transaction platform 17 may send clean or other type claims to the billing entity as shown by box 370 to be processed. Thereafter, funding by the funding entity 310 may take place as shown at 380. In step 6 the funding entity 310 checks available funds in the physicians line of credit (LOC) as noted in box 390 under the trustee 312 oversight.

In step 7, other claims may be sent to the physicians check out station for patient to check out. This information may be sent by the physician's management system. At this point, the patient may authorize payment from an appropriate account such as a debit, credit, HSA (Health Savings Account), ACH or the like and may suspend transaction until the claim amount is resolved with the payor. At the same time the payor 314 may move forward to pay any clean claim as noted in box 404.

Next in step 8, the billing entity 308 may move forward to initiate a claim to the payor for the clean amount and supplemental amount as shown in box 406. In response thereto, the payor 314 may receive the claim transaction amounts that is shown in box 408.

As shown in step 9, the billing entity has processed the clean claims and notifies the funding entity that transfers the amount as shown in box 410 into the physician's account shown by box 412 as quick as the next business day according to the principles of the invention.

As shown in step 10, the payor at this point may resolve the suspended “other” claim amount. Thereafter the billing entity 308 deletes or processes the charges accordingly as shown by box 414 and then such funds may be put into a physicians account as shown by box 416.

As shown in step 11 various reports may be sent to the various entities involved. In particular reports are sent to, for example, the funding entity 310 and the platform of the invention 304 in order to track the same.

Finally, previously determined clean claim amounts subsequently denied by the payor 314 may be charged back to the physician as noted in box 418 and deducted from the physicians account as noted by 420. Subsequently various electronic reports are again generated and forwarded to funding 310 and the platform of the invention 304.

FIGS. 2-4 are flow diagrams showing steps of an embodiment of the invention. FIGS. 2-4, as well as any other flow diagram herein, may equally represent a high-level block diagram of components of the invention implementing the steps thereof. All or a subset of the steps of FIGS. 2-4, and all the other flow diagrams, herein, may be implemented in computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Further, the computer code may also be embodied, at least in part, in a medium such as a carrier wave, which can be extracted and processed by a computer. Additionally, the computer program code and any associated parametric data can be transferred to a workstation over the Internet or some other type of network, perhaps encrypted, using a browser and/or using a carrier wave. The steps of FIGS. 2-4, as well as the other flow and relational flow diagrams herein, may also be implemented in type of computer hardware environment.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A process of ensuring that a payment is made by a payor for services rendered comprising the steps of:
receiving information indicating that a service has been rendered by a service provider and a payment process should be completed;
exchanging information with at least one entity regarding the service rendered by the service provider and the payment process; and
directing funding of the service provided by a service provider that has been provided after determining that payment is appropriate based on the information.

2. The process according to claim 1 wherein the at least one entity comprises one of an IHR patient database, a merchant processor, e-prescriber, a collections entity, trust administrator, claims administrator, a financial institution, and a PPO re-pricer.

3. The process according to claim 1 wherein exchanging information comprises receiving at least one of claims administration data from an insurance entity, payment information from a merchant processor, patient data, collections information, and medical data.

4. The process according to claim 1 wherein the entity comprise various individuals of the medical industry.

5. The process according to claim 1 wherein the service comprises a healthcare medical visit and payment process is the payment for the service.

6. The process according to claim 1 wherein the process further comprises patient fee collection.

7. The process according to claim 1 wherein the payment process further comprises merchant payment processing.

8. The process according to claim 1 wherein the process comprises an electronic prescription processing.

9. The process according to claim 1 wherein the process comprises receiving information from an electronic check-in.

10. The process according to claim 1 further comprising the step of administering claims through at least one of a PPO or a re-pricer.

11. The process according to claim 1 further comprising the step of funding the service provider with a first advance amount.

12. The process according to claim 11 further comprising the step of funding the service provider with a remaining advance amount.

13. The process according to claim 1 further comprising the step of recording data for the RHIO or for mining various outcomes based on received data.

14. A payment processing transaction system comprising:
a platform configured to receive information indicating that a service has been rendered by a service provider and a payment process should be completed;
said platform further configured to exchange information with at least one entity regarding the service rendered by the service provider and the payment process; and
said platform further configured to direct funding of the service provided by a service provider that has been provided after determining that payment is appropriate based on the information.

15. The system according to claim 14 wherein the at least one entity comprises one of an IHR patient database, a merchant processor, e-prescriber, a collections entity, trust administrator, claims administrator, a financial institution, and a PPO re-pricer.

16. The system according to claim 14 wherein exchanging information comprises receiving at least one of claims administration data from an insurance entity, payment information from a merchant processor, patient data, collections information, and medical data.

17. A system of ensuring that a payment is made by a payor for services rendered comprising:
means for receiving information indicating that a service has been rendered by a service provider and a payment process should be completed;
means for exchanging information with at least one entity regarding the service rendered by the service provider and the payment process; and
means for directing funding of the service provided by a service provider that has been provided after determining that payment is appropriate based on the information.

18. The system according to claim 17 wherein the at least one entity comprises one of an IHR patient database, a merchant processor, e-prescriber, a collections entity, trust administrator, claims administrator, a financial institution, and a PPO re-pricer.

19. The system according to claim 17 wherein exchanging information comprises receiving at least one of claims administration data from an insurance entity, payment information from a merchant processor, patient data, collections information, and medical data.
